(19) United States
(12) Patent Application Publication
(10) Pub. No.: US 2026/0292785 A1
(43) Pub. Date: Sep. 24, 2026

(54) METHODS, DEVICES, AND MEDIUM FOR COMMUNICATION

(71) Applicant: NEC Corporation, Tokyo (JP)

(72) Inventors: Da WANG, Beijing (CN); Lin LIANG, Beijing (CN); Gang WANG, Beijing (CN)

(73) Assignee: NEC Corporation, Tokyo (JP)

(21) Appl. No.: 18/881,126

(22) PCT Filed: Sep. 28, 2022
(86) PCT No.: PCT/CN2022/122173

§ 371 Date: Jan. 3, 2025

(51) Int. Cl. H04W 68/02; H04B 17/318; H04W 76/19; H04W 76/20

(52) U.S. Cl. CPC H04W 68/02; H04B 17/328; H04W 76/19; H04W 76/20

(57) ABSTRACT

Example embodiments of the present disclosure relate to an effective mechanism for processing the MT SDT. In this solution, the terminal device in an inactive state receives a paging message indicating a MT SDT from a first network device; determines, whether a condition or a set of conditions for performing an uplink SDT is met; and transmits, based on a result of the determining, a radio resource control (RRC) resume request message to the first network device. In this way, it is ensured that the following feedback information and optional uplink SDT may be transmitted to the first network device, and the uplink data amount upon initiating MT SDT is under control.

### FIELD

Example embodiments of the present disclosure generally relate to the field of communication techniques and in particular, to methods, devices, and medium for a mobile-terminated (MT) small data transmission (SDT).

### BACKGROUND

Power consumption of a terminal device is a focus in current wireless communication system. In order to reduce power consumption of the terminal device, it is proposed that the terminal device may be configured in some power saving modes/states (such as, inactive state). As for a terminal device in an inactive state, normal data transmissions are proposed to be suspended. Until the third generation partnership project (3GPP) Release 16, the inactive state cannot support data transmission. That is, if the terminal device in the inactive state needs to perform normal transmission with a network device, the terminal device has to resume a connection with the network device (i.e., wake up and transform into a connected state) for any downlink (i.e., MT) and uplink (i.e., mobile originated, MO) data. However, typically, a terminal device in an inactive state may still have small and infrequent data traffic to be transmitted, which results in unnecessary power consumption and signalling overhead.

In order to further reduce power consumption, a solution for enabling SDT (including both a MT SDT and MO SDT) for the terminal device in the inactive state is proposed by a work item of the 3GPP. By using SDT, the terminal device in the inactive state may maintain the inactive mode while enabling unlink transmission(s) and/or downlink transmission(s). Currently, it is still pending about the behaviors at the terminal device during the MT SDT, which may result in improper resuming procedure and complicated signalling interaction.

### SUMMARY

In general, embodiments of the present disclosure provide methods, devices and computer storage media for the MT SDT.

In a first aspect, there is provided a method of communication. The method comprises: receiving, at a terminal device in an inactive state and from a first network device, a paging message indicating a MT SDT; determining, whether a condition or a set of conditions for performing an uplink SDT is met; and transmitting, based on a result of the determining, a radio resource control (RRC) resume request message to the first network device.

In a second aspect, there is provided a method of communication. The method comprises: sending, at a first network device and to a terminal device, a paging message indicating a MT SDT; receiving, a first RRC resume request message from a terminal device, the first RRC resume request message indicating the MT SDT is initiated at the terminal device.

In a third aspect, there is provided a method of communication. The method comprises: receiving, at a terminal device and from a second network device serving the terminal device, an RRC release message, the RRC release message comprising at least one identity of the terminal device for MT SDT; and entering into an inactive state.

In a fourth aspect, there is provided a method of communication. The method comprises: generating, at a second network device serving a terminal device, an RRC release message used for transitioning the terminal device into an inactive state, the RRC release message comprising at least one identity of the terminal device for MT SDT; and transmitting the RRC release message to the terminal device.

In a fifth aspect, there is provided a method of communication. The method comprises: transmitting, at a first network device and to a terminal device, a paging message comprising one of the following: a 1-bit indication indicating whether the paging message is used for MT SDT, or one of the at least one identity of the terminal device for MT SDT.

In a sixth aspect, there is provided a method of communication. The method comprises: receiving, at a first network device and from a second network device, an RAN paging message indicating a MT SDT of a terminal device; transmitting, to the terminal device, a paging message for triggering the MT SDT; receiving a first RRC resume request message for MT SDT from the terminal device; and retrieving a partial context of the terminal device from the second network device without context relocation.

In a seventh aspect, there is provided a method of communication. The method comprises: transmitting, at a second network device and to a first network device, an RAN paging message indicating a MT SDT for a terminal device; and transferring a partial context of the terminal device to the first network device without context relocation.

In an eighth aspect, there is provided a method of communication. The method comprises: receiving, at a first network device, an Xn message from a second network device, the Xn message indicating at least one of the following: a partial context of a terminal device, used for SDT, a downlink SDT signalling, at least one resume MAC-I for cells belonging to a same RNA, at least one secure message authentication code for cells belonging to the same RNA, a first RRC release message for the terminal device; and transmitting, to a terminal device, a paging message for triggering a MT SDT.

In a ninth aspect, there is provided a method of communication. The method comprises: generating, at a second network device, an Xn message indicating at least one of the following: a partial context of a terminal device, used for SDT, a downlink SDT signalling, at least one resume MAC-I for cells belonging to the same RNA, at least one secure message authentication code for cells belonging to the same RNA, a first RRC release message for the terminal device; and transmitting, the Xn message to a first network device, the first network device and the second network device belonging to a same RNA.

In a tenth aspect, there is provided a terminal device. The terminal device includes a processing unit; and a memory coupled to the processing unit and storing instructions thereon, the instructions, when executed by the processing unit, causing the device to perform the method according to the first aspect.

In an eleventh aspect, there is provided a network device. The network device includes a processing unit; and a memory coupled to the processing unit and storing instructions thereon, the instructions, when executed by the processing unit, causing the network device to perform the method according to the second aspect.

In a twelfth aspect, there is provided a terminal device. The terminal device includes a processing unit; and a memory coupled to the processing unit and storing instructions thereon, the instructions, when executed by the processing unit, causing the device to perform the method according to the third aspect.

In a thirteenth aspect, there is provided a network device. The network device includes a processing unit; and a memory coupled to the processing unit and storing instructions thereon, the instructions, when executed by the processing unit, causing the network device to perform the method according to the fourth aspect.

In a fourteenth aspect, there is provided a network device. The network device includes a processing unit; and a memory coupled to the processing unit and storing instructions thereon, the instructions, when executed by the processing unit, causing the network device to perform the method according to the fifth aspect.

In a fifteenth aspect, there is provided a network device. The network device includes a processing unit; and a memory coupled to the processing unit and storing instructions thereon, the instructions, when executed by the processing unit, causing the network device to perform the method according to the sixth aspect.

In a sixteenth aspect, there is provided a network device. The network device includes a processing unit; and a memory coupled to the processing unit and storing instructions thereon, the instructions, when executed by the processing unit, causing the network device to perform the method according to the seventh aspect.

In a seventeenth aspect, there is provided a network device. The network device includes a processing unit; and a memory coupled to the processing unit and storing instructions thereon, the instructions, when executed by the processing unit, causing the network device to perform the method according to the eighth aspect.

In an eighteenth aspect, there is provided a network device. The network device includes a processing unit; and a memory coupled to the processing unit and storing instructions thereon, the instructions, when executed by the processing unit, causing the network device to perform the method according to the ninth aspect.

In a nineteenth aspect, there is provided a computer readable medium having instructions stored thereon, the instructions, when executed on at least one processor, causing the at least one processor to carry out the method according to any of the above first to ninth aspects.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1A illustrates a signaling flow for MT EDT procedure for user plane CIoT EPS optimisation according to some embodiments;

FIG. 1B illustrates a signaling flow for MO-SDT without UE context relocation;

FIG. 2 illustrates an example communication environment in which example embodiments of the present disclosure can be implemented;

FIG. 3 illustrates a signaling chart illustrating a process for communication according to some embodiments of the present disclosure;

FIG. 4 illustrates another signaling chart illustrating a process for communication according to some embodiments of the present disclosure;

FIG. 5 illustrates a further signaling chart illustrating a process for communication according to some embodiments of the present disclosure;

FIG. 6 illustrates a further signaling chart illustrating a process for communication according to some embodiments of the present disclosure;

FIG. 7 illustrates a further signaling chart illustrating a process for communication according to some embodiments of the present disclosure;

FIG. 8 illustrates an example method performed by the terminal device according to some embodiments of the present disclosure;

FIG. 9 illustrates an example method performed by the first network device according to some embodiments of the present disclosure;

FIG. 10 illustrates an example method performed by the terminal device according to some embodiments of the present disclosure;

FIG. 11 illustrates an example method performed by the second network device according to some embodiments of the present disclosure;

FIG. 12 illustrates an example method performed by the first network device according to some embodiments of the present disclosure;

FIG. 13 illustrates an example method performed by the first network device according to some embodiments of the present disclosure;

FIG. 14 illustrates an example method performed by the second network device according to some embodiments of the present disclosure;

FIG. 15 illustrates an example method performed by the first network device according to some embodiments of the present disclosure;

FIG. 16 illustrates an example method performed by the second network device according to some embodiments of the present disclosure; and

FIG. 17 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As discussed above, in order to reduce power consumption, a solution for enabling SDT (including both MT SDT and MO SDT) for the terminal device in the RRC inactive state is proposed by a work item of the 3GPP, such that the terminal device in the inactive RRC state may maintain the inactive RRC state while enabling a data transmission.

Some example application scenarios of SDT for a smart terminal device may include, but not limited to the following:
Traffic/data/packet from instant messaging services (for example, whatsapp, QQ, wechat, MSN, and the like);
Heart-beat/keep-alive traffic/data/packet from some applications (for example, instant application, email application, and the like); and
Push notifications from various applications.

Some example application scenarios of SDT for a non-smart terminal device may include, but not limited to the following:
Traffic/data/packet from wearables (for example, periodic positioning information and the like);
Traffic/data/packet from sensors (for example, industrial wireless sensor networks transmitting temperature, pressure readings periodically or in an event triggered manner); and
Periodic meter readings from smart mete device and smart meter network device.

In 3GPP release 17, solutions about MO SDT have been discussed, while solutions about MT SDT are still pending. Thus, in the following 3GPP release 18, more discussions about MT SDT are expected to be made. Specially, in the following 3GPP release 18, the work item of MT SDT is expected to specify the support for paging-triggered SDT (i.e., MT SDT), including:
MT SDT triggering mechanism for UEs in RRC_INACTIVE, supporting random access (RA) SDT and configured grant (CG) SDT as the uplink response;
MT SDT procedure for initial downlink data reception and subsequent uplink/downlink data transmissions in RRC_INACTIVE.

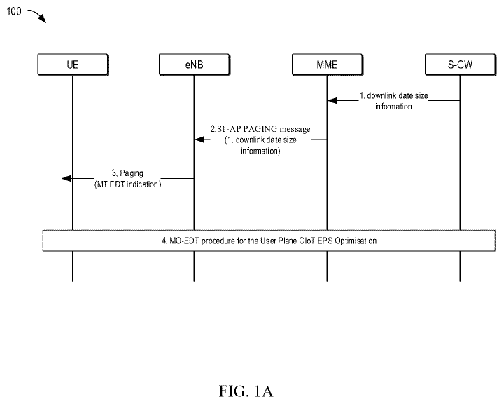

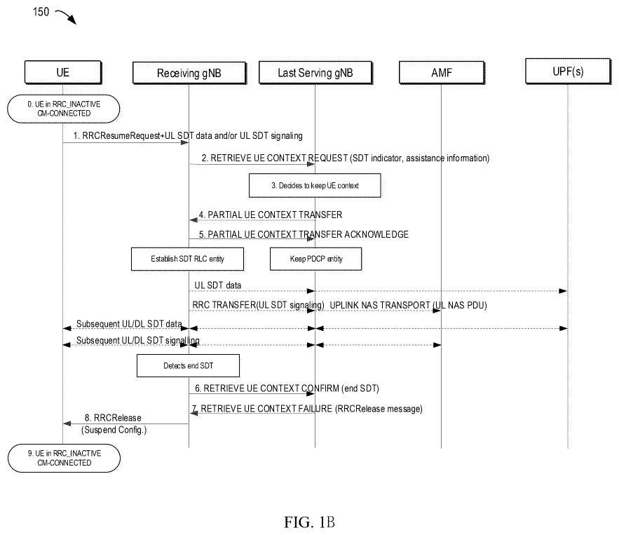

In some embodiments, a MT early data transmission (EDT) is proposed. Reference is made to FIG. 1A, which shows a signaling flow 100 for MT EDT procedure for user plane cellular internet of things (CIoT) evolved packet system (EPS) optimisation.

As illustrated in FIG. 1A, upon arrival of downlink data, the serving gateway (S-GW) may send the downlink data size to the mobility management entity (MME) for MT EDT consideration by the MME. Then, the MME includes the downlink data size in the S1-AP paging message to assist eNB in triggering MT-EDT. If the data can fit in one single downlink transmission according to the UE category included in the UE radio capability for paging provided in the S1-AP Paging message, the eNB includes mt-EDT indication in the Paging message for the UE.

Then, the UE initiates the MO EDT procedure for the user plane CIoT EPS optimisation, including: the UE selecting an RA preamble not configured for EDT; the UE sending an RRCConnectionResumeRequest message with the resume cause mt-EDT and without user data. Additionally, the MME may include the pending data indication in the S1-AP UE context resume response message to notify the eNB of further data traffic in excess of that initially signalled. The eNB may use this indication to decide whether to release the UE.

However, the above specific embodiment of FIG. 1A is proposed for MT EDT rather than MT SDT.

Further, in some embodiments, during a MO SDT, the MAC entity of the terminal device considers the suspended radio bearers (RBs) configured with SDT for data volume calculation. The terminal device may calculate the data volume for the suspended RBs in any suitable manner. Further, in some embodiments, size of the common control channel (CCCH) message is not considered for data volume calculation.

Additionally, in some embodiments, the MAC layer of the terminal device may perform as below.

| | |
|---|---|
| 1> | if the data volume of the pending UL data across all RBs configured for SDT is less than |

or equal to sdt-DataVolumeThreshold; and

| | |
|---|---|
| 1> | if the reference signal receiving power (RSRP) of the downlink pathloss reference is |

higher than sdt-RSRP-Threshold; or

| 1> | if sdt-RSRP-Threshold is not configured: | |
|---|---|---|
| | 2> | if the Serving Cell for SDT is configured with supplementary uplink; and |
| | 2> | if the RSRP of the downlink pathloss reference is less than rsrp-ThresholdSSB-SUL: |
| | | 3> select the supplementary uplink (SUL) carrier. |
| | 2> | else: |
| | | 3> select the normal uplink (NUL) carrier. |
| | 2> | if CG SDT is configured on the selected uplink carrier, and timing advance (TA) of |
| | the configured grant Type 1 resource is valid; and | |
| | 2> | if at least one synchronization signal and physical broadcast channel (PBCH) block |
| | (SSB) configured for CG SDT with synchronization signal (SS)-RSRP above cg-SDT- | |
| | RSRP-ThresholdSSB is available: | |
| 3> | indicate to the upper layers that the conditions for initiating SDT procedure are fulfilled; | |
| 3> | perform CG SDT procedure on the selected UL carrier. | |
| | 2> | else if a set of RA resources for performing RA SDT are selected on the selected |
| | uplink carrier: | |
| | | 3> consider cg-SDT-TimeAlignmentTimer as expired and perform the |
| | corresponding actions; | |
| | | 3> indicate to the upper layers that the conditions for initiating SDT procedure are |
| | fulfilled. | |
| | 2> | else: |
| | | 3> indicate to the upper layers that the conditions for initiating SDT procedure are |
| | not fulfilled. | |
| 1> | else: | |
| | 2> | indicate to the upper layers that the conditions for initiating SDT procedure are not |

fulfilled.

However, the above specific embodiment is proposed for MO SDT rather than MT SDT.

Further, in some embodiments, a MO-SDT without UE context relocation is proposed (as illustrated in FIG. 1B). However, the specific embodiment of FIG. 1B is proposed for MO SDT rather than MT SDT.

Though the above discussions, it can be seen that there are a plurality of pending issues needed to be further discussed. Embodiments of the present disclosure provide solutions for MT SDT. According to some embodiments of the present discourse, the terminal device may determine whether a condition or a set of conditions for performing an uplink SDT is met, and may transmit an RRC resume request message to the first network device based on a result of the determining. In this way, the following uplink SDT may be proceeded properly. Further, according to some other embodiments of the present discourse, the MT SDT may be indicated in the paging message without impacting paging capacity, and further an enhanced procedure of MT SDT without UE context relocation is enabled.

For ease of discussion, some terms used in the following description are listed as below:
A first network device: refers to a network device providing a coverage area. Further, the terminal device is currently in the coverage area of the first network device. In some embodiment, as for a terminal device in an inactive state, the first network device may be the last serving network device (i.e., the last serving gNB), or a new/received network device (i.e., the new/received gNB).
A second network device: refers to a network device transmitting an RRC release message to the terminal device, such that the terminal may transition into an inactive state. In some embodiments, the second network device is the last serving network device (i.e., the last serving gNB).

Principles and implementations of the present disclosure will be described in detail below with reference to the figures.

### Example of Communication Network

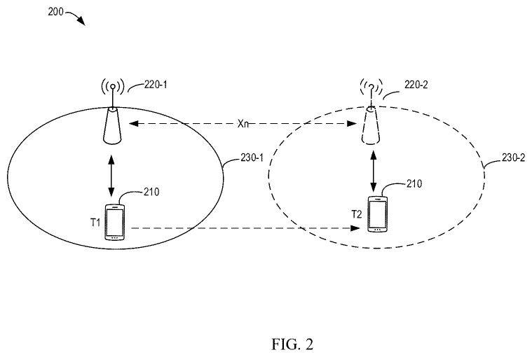

FIG. 2 shows an example communication environment 200 in which example embodiments of the present disclosure can be implemented. The network communication 200 includes a terminal device 210, a network device 220-1 and an optional network device 220-2. In the following text, the network devices 220-1 and 220-2 are collectively referred to as the network devices 220 or individually referred to as the network device 220. Additionally, the network devices 220 may provide one or more coverage areas. In the specific example of FIG. 2, the network device 220-1 provides coverage area 230-1 and the network device 220-2 provides coverage area 230-2.

In the communication environment 200, a link from the terminal device 210 to the network device 220 is referred to as an uplink, while a link from the network device 220 to the terminal device 210 is referred to as a downlink. In downlink, the network device 220 is a transmitting (TX) device (or a transmitter) and the terminal device 210 is a receiving (RX) device (or a receiver). In uplink, the terminal device 210 is a TX device (or a transmitter) and the network device 220 is a RX device (or a receiver).

In the specific example of FIG. 2, the terminal device 210 may be in different states (such as, connected state, inactive state and idle state). When the terminal device 210 is in the connected state, the terminal device 210 can perform transmission of data from all RBs. Further, in some embodiments, when the terminal device 210 is in idle state, the terminal device usually is not allowed to perform any data transmission. In addition, when the terminal device 210 is in the inactive state, an SDT is supported while a transmission of data configured with SDT is allowed during an SDT procedure.

Further, a terminal device 210 in the inactive/idle state may transition into the connected state by resuming/establishing an RRC connection with the network device 220. Such transition procedures may be initiated by either the terminal device 210 or the network device 220.

In addition, in the example of FIG. 2, the terminal device 210 may move over time. As illustrated in FIG. 2, the terminal device 210 locates at different positions at different time points (T1 and T2). When moving, the terminal device 210 may communicate with different network devices 220.

In some embodiments, the network device 220-1 and the network device 220-1 are in a same radio access network (RAN) notification area (RNA), and may communicate with each other via Xn message(s).

It is to be understood that the number of devices and their connections in FIG. 2 are given for the purpose of illustration without suggesting any limitations to the present disclosure. The communication environment 200 may include any suitable number of network devices and/or terminal devices and/or coverage areas for implementing implementations of the present disclosure.

In some embodiments, the terminal device 210 and the network device 220 may communicate with each other via a channel such as a wireless communication channel on an air interface (e.g., Uu interface). The wireless communication channel may comprise a PUCCH, a PUSCH, a physical random-access channel (PRACH), a physical downlink control channel (PDCCH), a PDSCH and a physical broadcast channel (PBCH). Of course, any other suitable channels are also feasible.

The communications in the communication environment 200 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

### Example of Processes

It should be understood that although feature(s)/operation(s) are discussed in specific example embodiments separately, unless clearly indicated to the contrary, these feature(s)/operation(s) described in different example embodiments may be used in any suitable combination.

In addition, in the following description, some interactions are performed among the terminal device 210 and the network device 220. It is to be understood that the interactions may be implemented either in one single signaling/message or multiple signaling/messages, including system information (SI), RRC message, DCI message, uplink control information (UCI) message, media access control (MAC) control element (CE) and so on. The present disclosure is not limited in this regard.

The below embodiments will be described with reference to FIG. 2. Further, two specific scenarios should be considered within the scopes in the present disclosure.
Scenario #1: the terminal device 210 is originally in a connected state and connected to the network device 220-1. Then the terminal device 210 receives an RRC release message from the network device 220-1 and enters into an inactive state. In the following, a MT SDT for the terminal device 210 occurs, and the terminal device 210 is in the coverage area of the network device 220-1.
In this specific scenario #1, the first network device is the network device 220-1, and the second network device also is the network device 220-1.
Scenario #2: the terminal device 210 is originally in a connected state and connected to the network device 220-1. Then the terminal device 210 receives an RRC release message from the network device 220-1 and enters into an inactive state. In the following, a MT SDT for the terminal device 210 occurs, and the terminal device 210 is in the coverage area of the network device 220-2, due to such as the moving of the terminal device 210 or the change of the communication condition.
In this specific scenario #2, the first network device is the network device 220-2, and the second network device is the network device 220-1.

Further, in the below example embodiments, the first network device and the second network device belong to a same RNA.

### Example Processes for Configuring the Identity for MT SDT

In some embodiments, a MT SDT may be triggered by a paging message. According to some embodiments, the MT SDT may be indicated in the paging message by different manners. In one specific embodiment, the first network device may transmit a paging message comprising a 1-bit indication (also referred to as MT SDT indication sometimes) indicating whether the paging message is used for MT SDT. In this way, the MT SDT may be indicated in a relative easier way. However, due to the newly-introduced 1-bit indication, the paging capability would be reduced. In view of this, in another specific embodiment, the first network device may transmit a paging message comprising an identity of the terminal device for MT SDT. In this way, there is no need to introducing any new indication, and the paging capacity is not impacted accordingly.

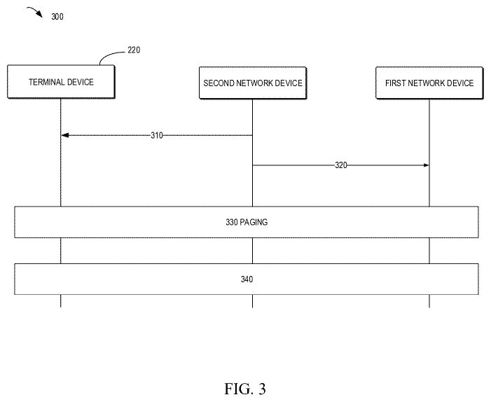

In the following, examples regarding how to configure identity(ies) of the terminal device 210 will be discussed in detail with reference to FIG. 3, which shows a signaling chart illustrating a process 300 for communication according to some embodiments of the present disclosure.

The terminal device 210 is originally in a connected state and connected to the second network device. That is, the second network device is serving the terminal device 210.

In operation, the second network device generates an RRC release message used for transitioning the terminal device 210 into an inactive state. In particular, the RRC release message comprises at least one identity of the terminal device 210 for MT SDT. Then, the second network device transmits 310 the RRC release message to the terminal device 210.

Additionally, in some embodiment, the at least one identity is comprised in the information element (IE) of “suspendConfig” in the RRC release message. It should be understood that IE of “suspendConfig” is given for illustrative purpose only. In the other embodiments, the at least one identity may be indicated in other IE. The present disclosure is not limited in this regard.

In this way, the at least one identity of the terminal device 210 for MT SDT is configured and indicated to the terminal device 210.

In some embodiments, the at least one identity of the terminal device 210 for MT SDT is at least one RNTI for MT SDT.

In some embodiments, the at least one identity for MT SDT comprises at least one of the following: a first identity with a first bit length (also may be referred to as short RNTI for MT SDT), or a second identity with a second bit length longer than the first bit length (also may be referred to as full RNTI for MT SDT). As one specific embodiment, the at least one identity for MT SDT comprises a first RNTI for MT SDT with 40 bits and a second RNTI for MT SDT with 24 bits.

Considering that the terminal device 210 may move out of the coverage area of the second network device, the second network device also transmits Xn message(s) to the other network device(s) in the same RNA. As shown in FIG. 3, the second network device transmit 320 an Xn message comprising the at least one identity of the terminal device 210 for MT SDT to the first network device.

Additionally, in some embodiments, the Xn message is an RAN paging message. It should be understood that the RAN paging message is given for illustrative purpose only. In the other embodiments, the at least one identity may be indicated in other Xn message. The present disclosure is not limited in this regard.

In this way, all the network devices in the same RNA may obtain the at least one identity of the terminal device 210 for MT SDT. As a result, except for using the 1-bit indication (i.e., MT SDT indication), the network device also may use one of the at least one identity to initiate 330 the MT SDT. Specifically, in the following, the network device (either the first network device or the second network device) may use one of the least one identity of the terminal device 210 for MT SDT to initiate a MT SDT. If the terminal device 210 receives a paging message comprising an identity of the at least one identity for MT SDT, the terminal device 210 will understand that a MT SDT is initiated by the network device.

As illustrated FIG. 3, both the first network device and the second network device transmit a paging message comprising one of the at least one identity of the terminal device for MT SDT to the terminal device 210. In some embodiments, the paging message comprises the second identity with a second bit length (such as, a full RNTI for MT SDT).

In some embodiments, when the terminal device 210 in inactive state is configured with the at least one identity for MT SDT, the terminal device 210 may monitor a paging channel for RAN paging using both inactive RNTI (I-RNTI) and RNTI(s) for MT SDT.

In the specific embodiment of FIG. 3, the terminal device 210 may perform 340 a resume procedure to respond the paging message.

In some embodiments, the terminal device 210 may transmits a first RRC resume message comprising one of the at least one identity of the terminal device for MT SDT to indicate that the MT SDT is initiated at the terminal device 210.

In some embodiments, whether to use the first identity or the second identity in the RRC resume message may be configured by the network device 220. Specifically, in some embodiments, the terminal device 210 receives system information (SI) from the first network device, where the SI indicates whether the first identity or the second identity is to be used by the terminal device 210.

In some embodiments, if the SI indicates that the first identity with the first bit length is to be used, the terminal device 210 transmits the first RRC resume request message with a first format. Alternatively, if the SI indicates that the second identity with the second bit length is to be used, the terminal device 210 transmits the first RRC resume request message with a second format different from the first format.

In one specific embodiment, if the second identity is determined to be used, the terminal device 210 transmits the RRCResumeRequest1 message includes the second identity (i.e., the full RNTI for MT SDT). Alternatively, if the first identity is determined to be used, the terminal device 210 transmits the RRCResumeRequest message includes the first identity (i.e., short RNTI for MT SDT).

### Example Processes for Condition for Performing MT SDT

According to some embodiments of the present disclosures, after receiving a paging message for MT SDT, the terminal device 210 would determine whether it is suitable to initiate the MT SDT, because the channel condition may be not available for transmitting feedback information or uplink SDT during the MT SDT, or there may be a lot of pending uplink data across all RBs configured for SDT, which may have influences on the MT SDT.

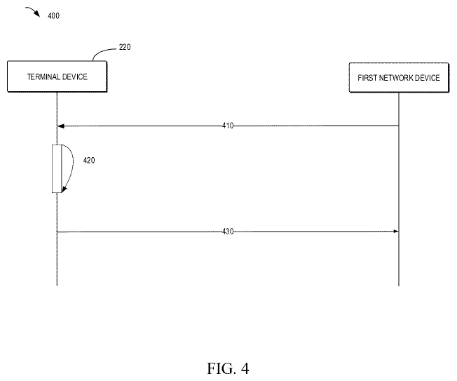

In the following, examples regarding whether to initiate the MT SDT will be discussed in detail with reference to FIG. 4, which shows a signaling chart illustrating a process 400 for communication according to some embodiments of the present disclosure.

In operation, the terminal device 210 receives 410 a paging message indicating a MT SDT from the first network device. Additionally, in some embodiments, the panging message may indicate the MT SDT as discussed above.

After receiving the paging message, the terminal device 210 determines whether a condition or a set of conditions for performing an uplink SDT is met. In some embodiments, upon reception of the paging message indicating MT SDT, the RRC layer of the terminal device indicates to the lower layers of the terminal device 210 that an MT SDT/SDT is triggered. Then, a MAC layer of the terminal device 210 may check a condition (or a set of conditions) to determine whether the MT SDT may be suitable to be performed.

In some embodiment, the terminal device 210 determines the condition is met or one of the set of conditions is met if a channel quality parameter of downlink pathloss reference is higher than a power threshold. Alternatively, the terminal device 210 determines the condition is not met if the channel quality parameter of downlink pathloss reference is lower than or equals to than the power threshold.

Additionally, in some embodiment, the channel quality parameter is an RSRP of downlink pathloss reference.

In this way, it is ensured that the following feedback information and optional uplink SDT may be transmitted to the first network device.

Alternatively, or in addition, in some embodiment, the terminal device 210 determines the condition is met or one of the set of conditions is met if a data volume of pending uplink data across all RBs configured for SDT (or MT SDT) is less than or equals to a threshold volume. Alternatively, the terminal device 210 determines the condition is not met if the data volume of the pending uplink data across all RBs configured for SDT (or MT SDT) is larger than the threshold volume.

In this way, the uplink data amount upon initiating MT SDT is under control.

In some embodiment, if the condition is fulfilled (or the set of conditions is fulfilled), the MAC layer of the terminal device 210 may indicate to the upper layers that the condition or conditions for initiating MT SDT/SDT procedure is fulfilled.

Then the RRC layer of the terminal device 210 may initiate RRC resume procedure for SDT. Further, in some embodiments, the terminal device 210 (such as, the RRC entity) may transmit 430 an RRC resume request message to the first network device based on a result of the determining.

Specifically, in some embodiment, if the condition is met or the set of conditions is met, the terminal device 210 may transmit a first RRC resume request message to the first network device, where the first RRC resume request message indicates the MT SDT is initiated at the terminal device.

In some embodiments, the first RRC resume request message indicating the MT SDT by comprising a resume cause indicating MT SDT. In one specific embodiments, the terminal device 210 sets the resumeCause in RRCResumeRequest/RRCResumeRequest1 message as a value indicating MT SDT.

Alternatively, in some embodiment, the first RRC resume request message indicating the MT SDT by comprising an identity of the terminal device for MT SDT (as discussed above).

In some embodiments, if the condition is met or the set of conditions is met, the MAC entity may indicate to the upper layer of the terminal device 210 that the condition is met.

In some embodiments, if the condition is not met (or at least one of the set of conditions is not fulfilled), the terminal device 210 may transmit a second RRC resume request message to the first network device, where the second RRC resume request message indicate the MT SDT is not initiated at the terminal device. In some embodiments, the second RRC resume request message is used for transitioning the terminal device from an inactive state into a connected state.

In some embodiments, the second RRC resume request message indicating the MT SDT is not initiated at the terminal device by comprising a resume cause indicating MT access. Alternatively, in some embodiment, the second RRC resume request message indicating the MT SDT is not initiated at the terminal device by comprising an I-RNTI (full I-RNTI or short I-RNTI).

In one specific embodiment, if the condition is not met (or at least one of the set of conditions is not fulfilled), the MAC layer of the terminal device 210 indicates to the upper layers that the condition(s) for initiating MDT-SDT/SDT procedure is not fulfilled. Then the RRC layer of the terminal device 210 initiates an RRC resume procedure (not for SDT), where resumeCause in RRCResumeRequest message may be set as “mt-Access”, or set the resumeIdentity in RRCResumeRequest/RRCResumeRequest1 as the I-RNTI (either short I-RNTI or full I-RNTI).

In some embodiments, if the condition is not met, the MAC entity indicates to the upper layer of the terminal device 210 that the condition is not met.

In this way, it is ensured that the following feedback information and optional uplink SDT may be transmitted to the first network device, and the uplink data amount upon initiating MT SDT is under control.

### Example Processes for MT SDT without Context Relocation

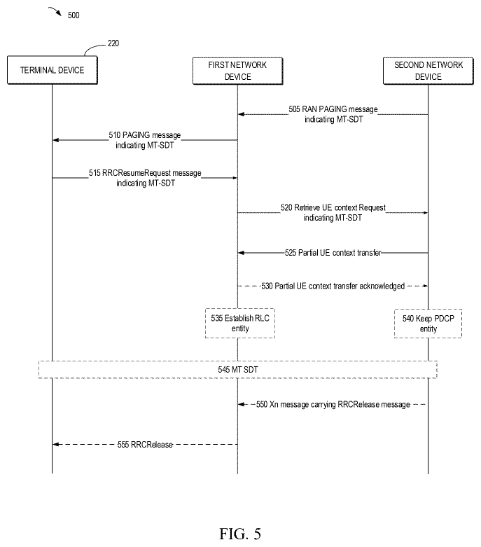

According to some embodiments of the present disclosures, an enhanced MT SDT without context relocation is proposed. In the following, examples regarding MT SDT without context relocation will be discussed in detail with reference to FIGS. 5 to 7, which show signaling charts illustrating processes 500, 600 and 700 for communication according to some embodiments of the present disclosure.

Reference is made to FIG. 5 now. In operation, the second network device (i.e., the last serving gNB, such as, the network device 210-1) decides to trigger a MT SDT for the terminal device 210. As the terminal device 210 is in the inactive state, the terminal device 210 may be out of the coverage of the second network device. In the specific embodiment of FIG. 5, the terminal device 210 has moved into the coverage area of the first network device (such as, the network device 210-2).

Considering that the terminal device 210 may move out of the coverage area of the second network device, the second network device may transmit RAN panging message(s) to the other network device(s) in the same RNA, such as in a broadcast/multicast manner.

As illustrated in FIG. 5, upon the determination of MT SDT, the second network device transmits 505 an RAN panging message indicating MT SDT to the first network device. In this way, all the network device within the RNA may page the terminal device 210.

As for the first network device, upon the RAN paging message for MT SDT, the first network device transmits 510 a paging message for triggering the MT SDT to the terminal device 210.

In the specific embodiment of FIG. 5, the terminal device 210 determines to initiates the MT SDT and transmits 515 a first RRC resume request message for MT SDT to the first network device.

Next, the first network device may retrieve a partial context of the terminal device 210 from the second network device. As illustrated in FIG. 5, the first network device transmits 520 a context request for retrieving the partial context of the terminal device (such as, a Retrieve UE context Request indicating MT SDT) to the second network device. As a result of without UE context relocation, the second network device transmits 525 a partial context of the terminal device 210 to the first network device.

Optionally, in some embodiments, the first network device may transmit 530 an acknowledge for the partial context of the terminal device 210 (Partial UE context transfer acknowledged) to the second network device. With the partial context of the terminal device 210, the first network device may establish 535 the RLC entity.

In case of the MT SDT without context relocation, the second network device keeps 540 the PDCP entity.

Then, the MT SDT may be performed 545. Specifically, downlink SDT data/signalling may be transmitted from the second network device to the terminal device 210 via the first network device, while uplink SDT data/signalling may be transmitted from the terminal device 210 to the second network device via the first network device.

Upon a termination of the MT SDT, the second network device transmits 550 Xn message carrying a first radio resource control (RRC) release message for the terminal device 210 to the first network device. Then, the first network device may transmit a second RRC release message corresponding to the first RRC release message to the terminal device 210 (such as, forward the first RRC release message to the terminal device 210 directly).

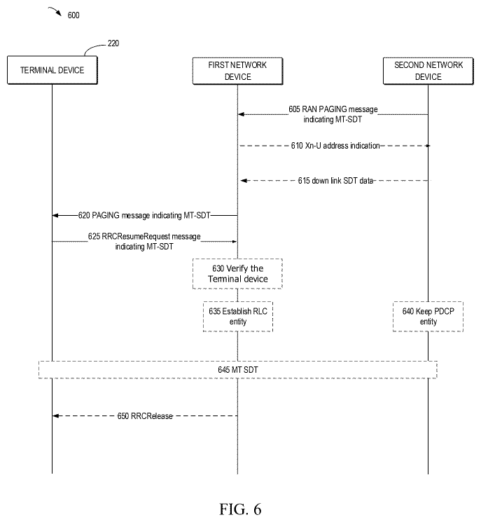

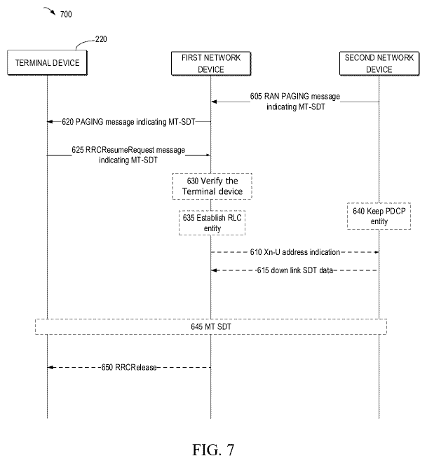

In this way, the MT SDT without context relocation may be proceeded properly. Further, according to some embodiment of the present disclosure, the signalling interaction of FIG. 5 may be further enhanced, which will be discussed with reference to FIGS. 6 and 7.

In some embodiments, if the second network device decides to perform MT SDT, and decides to not relocate UE context, the second network device may provide the information to be used during the MT SDT to the first network device in advance. For example, the second network device provide the related information to all the network device(s) within the same RNA via such as a broadcast/multicast manner. In this way, the signalling interaction between the second network device and the first network device is simplified.

As shown in FIG. 6, the first network device transmits 605 an Xn message to the first network device, where the Xn message indicates at least one of the following:
a partial context of the terminal device 210, used for SDT,
a downlink SDT signalling,
at least one resume MAC-I for cells belonging to a same RNA,
at least one secure message authentication code for cells belonging to the same RNA,
a first radio resource control (RRC) release message for the terminal device.

With the partial context of the terminal device 210, the signalling interaction for retrieving the partial context of the terminal device 210 among the first network device and the second network device may be saved.

Alternatively, or in addition, with the downlink SDT signalling, the signalling interaction for communicating downlink SDT signalling among the first network device and the second network device may be saved.

Alternatively, or in addition, with the first RRC release message, the signalling interaction for transmitting the Xn message carrying the first RRC release message among the first network device and the second network device may be saved.

Alternatively, or in addition, with the at least one resume MAC-I for cells belonging to a same RNA (which may be used by the MAC layer for such as data integrity of signalling messages), and/or at least one secure message authentication code for cells belonging to the same RNA (such as, message authentication code), the first network device may verify the terminal device 210 without assistant from the second network device.

It is to be understand that the Xn message may comprise one or more example parameters (i.e., the partial context of the terminal device 210, the downlink SDT signalling, the at least one resume MAC-I for cells belonging to a same RNA, the at least one secure message authentication code for cells belonging to the same RNA, and the first RRC release message). As a general rule, if the related parameters are comprised in the Xn message, the related signalling interaction among the first network device and the second network device may be saved. Else, the first network device may obtain related parameters from the second network device. Merely for brevity, the present disclosure does not illustrate the possibly combinations in an exhaustivity manner.

In some embodiments, the Xn message is an RAN paging message.

In some embodiments, prior to paging the terminal device 210, the first network device may transmit 610 Xn-U address indication to the second network device and receive 615 downlink SDT data from the second network device.

Next, the first network device transmits 620 a paging message for triggering the MT SDT to the terminal device 210. In the specific embodiment of FIG. 6, the terminal device 210 determines to initiates the MT SDT and transmits 625 a first RRC resume request message for MT SDT to the first network device.

In case that the first network device has obtained the verification information (such as, MAC-I, secure message authentication code), the first network device may verify 630 the terminal device. As one specific embodiment, upon reception of RRCResumeRequest message from the terminal device 210, the first network device verifies the terminal device 210 based on the resume MAC-I received from the terminal device 210 and the resume MAC-I comprised in the Xn message.

Further, in case that the first network device has obtained the partial context of the terminal device 210 the first network device may establish 635 the RLC entity. In case of the MT SDT without context relocation, the second network device keeps 640 the PDCP entity.

After that, the MT SDT may be performed 645. Specifically, downlink SDT data/signalling may be transmitted to the terminal device 210 by the first network device directly (as the downlink SDT data/signalling has been obtained by the first network device), while uplink SDT data/signalling may be transmitted from the terminal device 210 to the second network device via the first network device.

Upon a termination of the MT SDT, in case that the first network device has obtained the first RRC release for the terminal device 210 in the Xn message. The first network device may transmit 650 a second RRC release message corresponding to the first RRC release message to the terminal device 210.

Further, the signalling order in the specific embodiment of FIG. 6 may be adjusted. Specifically, transmitting the Xn-U address indication from the first network device to the second network device may be performed in response to reception of a first RRC resume request message for the MT SDT from the terminal device (as shown in FIG. 7).

In this way, the signalling interaction for MT SDT without context relocation is further enhanced.

### Example of Methods

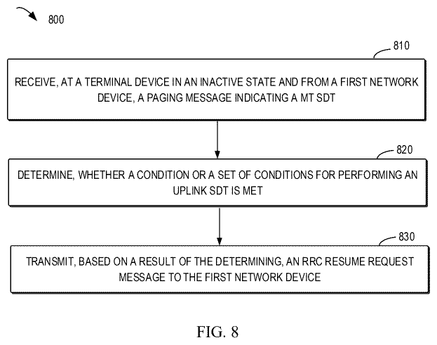

FIG. 8 illustrates a flowchart of an example method 800 in accordance with some embodiments of the present disclosure. For example, the method 800 can be implemented at the terminal device 210 as shown in FIG. 2.

At block 810, a terminal device 210 in an inactive state receives a paging message indicating a MT SDT from a first network device.

At block 820, a terminal device 210 determines, whether a condition or a set of conditions for performing an uplink SDT is met.

At block 830, a terminal device 210 transmits, based on a result of the determining, an RRC resume request message to the first network device.

In some embodiments, determining whether the condition for performing the uplink SDT is met comprises: determining the condition is met if a channel quality parameter of downlink pathloss reference is higher than a power threshold; or determining the condition is not met if the channel quality parameter of downlink pathloss reference is lower than or equals to than the power threshold.

In some embodiments, the channel quality parameter is an RSRP of downlink pathloss reference.

In some embodiments, determining whether the condition for performing the uplink SDT is met comprises: determining the condition is met if a data volume of pending uplink data across all RBs configured for SDT is less than or equals to a threshold volume; or determining the condition is not met if the data volume of the pending uplink data across all RBs configured for SDT is larger than the threshold volume.

In some embodiments, transmitting the RRC resume request message to the first network device comprises: in accordance with a determination that the condition or the set of conditions is met, transmitting a first RRC resume request message to the first network device, the first RRC resume request message indicating the MT SDT is initiated at the terminal device 210.

In some embodiments, the first RRC resume request message indicating the MT SDT is initiated at the terminal device 210 by comprising at least one of the following: a resume cause indicating MT SDT, or an identity of the terminal device 210 for MT SDT.

In some embodiments, transmitting the RRC resume request message to the first network device comprises: in accordance with a determination that the condition or at least one of the set of conditions is not met, transmitting a second RRC resume request message to the first network device, the second RRC resume request message indicating the MT SDT is not initiated at the terminal device 210.

In some embodiments, the second RRC resume request message indicating the MT SDT is not initiated at the terminal device 210 by comprising at least one of the following: a resume cause indicating MT access, or an inactive RSRP.

In some embodiments, in accordance with a determination that the condition or the set of conditions is met, the terminal device 210 indicates, at a MAC entity of the terminal device 210, to an upper layer of the terminal device 210 that the condition is met.

In some embodiments, in accordance with a determination that the condition or at least one of the set of conditions is not met, the terminal device 210 indicates at the MAC entity of the terminal device 210, to the upper layers of the terminal device 210 that the condition is not met.

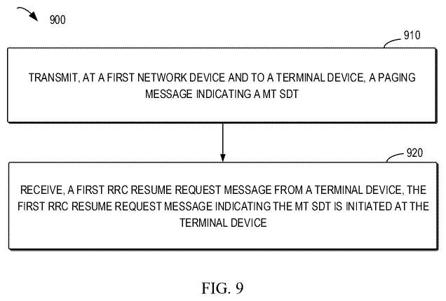

FIG. 9 illustrates a flowchart of an example method 900 in accordance with some embodiments of the present disclosure. For example, the method 900 can be implemented at the network device 220-1/220-2 as shown in FIG. 2.

At block 910, a first network device transmits, at a first network device and to a terminal device 210, a paging message indicating a MT SDT.

At block 920, a first network device receives, a first RRC resume request message from a terminal device 210, the first RRC resume request message indicating the MT SDT is initiated at the terminal device 210.

In some embodiments, the first RRC resume request message comprises at least one of the following: a resume cause indicating MT SDT, or an identity of the terminal device 210 for MT SDT.

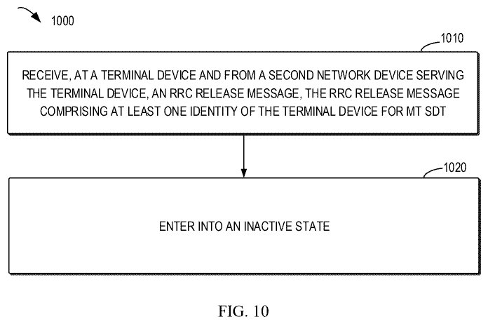

FIG. 10 illustrates a flowchart of an example method 1000 in accordance with some embodiments of the present disclosure. For example, the method 1000 can be implemented at the terminal device 210 as shown in FIG. 2.

At block 1010, a terminal device 210 receives an RRC release message from a second network device serving the terminal device 210, the RRC release message comprising at least one identity of the terminal device 210 for MT SDT.

At block 1020, a terminal device 210 enters into an inactive state.

In some embodiments, the at least one identity of the terminal device 210 for MT SDT is at least one RSRP for MT SDT.

In some embodiments, the at least one identity for MT SDT comprises at least one of the following: a first identity with a first bit length, or a second identity with a second bit length longer than the first bit length.

In some embodiments, the terminal device 210 receives a paging message from a first network device, the paging message comprising one of the following: a 1-bit indication indicating whether the paging message is used for MT SDT, or one of the at least one identity of the terminal device 210 for MT SDT.

In some embodiments, if an MT SDT is determined to be initiated, the terminal device 210 transmits a first RRC resume request message to the first network device, the first RRC request comprising one of the at least one identity of the terminal device 210.

In some embodiments, the terminal device 210 receives SI from the first network device, the SI indicating whether a first identity with a first bit length or a second identity with a second bit length is to be used by the terminal device 210.

In some embodiments, the transmitting the first RRC resume request message comprises: if the SI indicates that the first identity with the first bit length is to be used, transmitting the first RRC resume request message with a first format; and if the SI indicates that the second identity with the second bit length is to be used, transmitting the first RRC resume request message with a second format different from the first format.

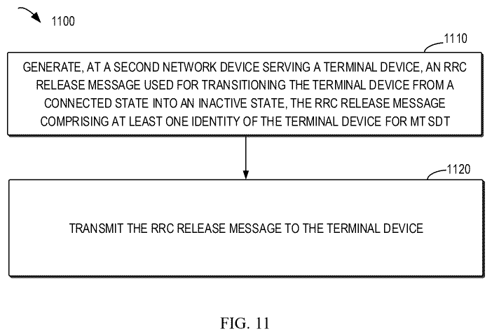

FIG. 11 illustrates a flowchart of an example method 1100 in accordance with some embodiments of the present disclosure. For example, the method 1100 can be implemented at the network device 220-1 as shown in FIG. 2.

At block 1110, a second network device serving a terminal device 210 generates, an RRC release message used for transitioning the terminal device 210 into an inactive state, the RRC release message comprising at least one identity of the terminal device 210 for MT SDT.

At block 1120, a second network device transmits the RRC release message to the terminal device 210.

In some embodiments, the at least one identity of the terminal device 210 for MT SDT is at least one RSRP for MT SDT.

In some embodiments, the at least one identity for MT SDT comprises at least one of the following: a first identity with a first bit length, or a second identity with a second bit length longer than the first bit length.

In some embodiments, the second network device transmits SI to the terminal device 210, the SI indicating whether the first identity with the first bit length or the second identity with the second bit length is to be used by the terminal device 210.

In some embodiments, the second network device transmits an Xn message comprising the at least one identity of the terminal device 210 for MT SDT to the second network device, the first network device and the second network device belonging to a same RNA.

In some embodiments, the Xn message is an RAN paging message.

In some embodiments, the second network device transmits, to the terminal device 210, a paging message comprising at least one of the following: a 1-bit indication indicating whether the paging message is used for MT SDT, or one of the at least one identity of the terminal device 210 for MT SDT.

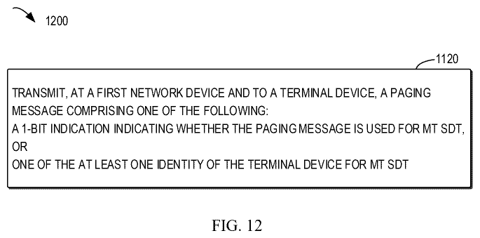

FIG. 12 illustrates a flowchart of an example method 1200 in accordance with some embodiments of the present disclosure. For example, the method 1200 can be implemented at the network device 220-1/220-2 as shown in FIG. 2.

At block 1210, a first network device transmits, at a first network device and to a terminal device 210, a paging message comprising one of the following: a 1-bit indication indicating whether the paging message is used for MT SDT, or one of the at least one identity of the terminal device 210 for MT SDT.

In some embodiments, the first network device receives, from a second network device, an Xn message comprising at least one identity of a terminal device 210 for MT SDT, wherein the first network device and the second network device belong to a same RNA. In some embodiments, the Xn message is an RAN paging message.

In some embodiments, the first network device receives a first RRC resume request message from a terminal device 210, the first RRC request comprising one of the at least one identity of the terminal device 210.

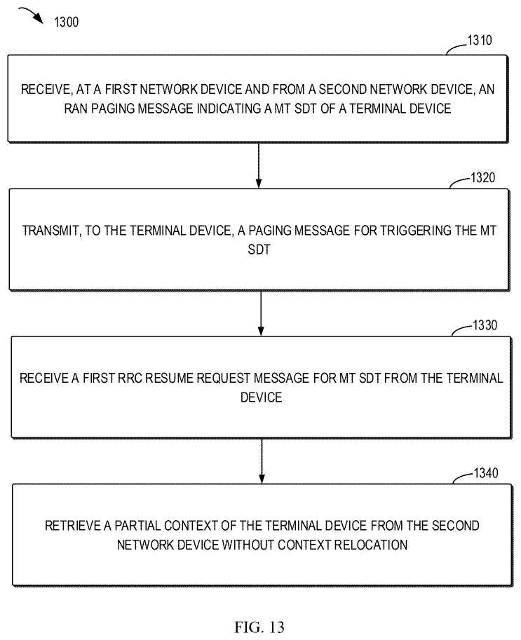

FIG. 13 illustrates a flowchart of an example method 1300 in accordance with some embodiments of the present disclosure. For example, the method 1300 can be implemented at the network device 220-1/220-2 as shown in FIG. 2.

At block 1310, a first network device receives an RAN paging message indicating a MT SDT of a terminal device 210 from a second network device.

At block 1320, a first network device transmits to the terminal device 210, a paging message for triggering the MT SDT.

At block 1330, a first network device receives a first RRC resume request message for MT SDT from the terminal device 210.

At block 1340, a first network device retrieves a partial context of the terminal device 210 from the second network device without context relocation.

In some embodiments, retrieving the partial context of the terminal device 210 without context relocation comprises: transmitting, to the second network device, a context request for retrieving the partial context of the terminal device 210; and receiving, from the second network device, a partial context of the terminal device 210.

In some embodiments, after a completion of the MT SDT, the first network device receives an Xn message from the second network device, the Xn message carrying a first RRC release message for the terminal device 210; and transmits, to the terminal device 210, a second RRC release message corresponding to the first RRC release message.

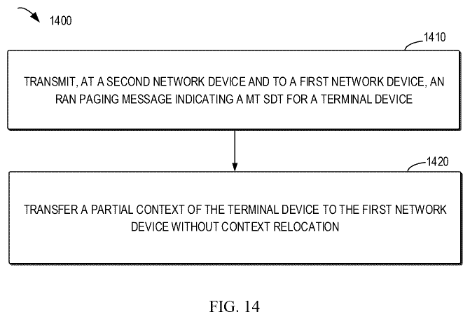

FIG. 14 illustrates a flowchart of an example method 1400 in accordance with some embodiments of the present disclosure. For example, the method 1400 can be implemented at the network device 220-1 as shown in FIG. 2.

At block 1410, a second network device transmits an RAN paging message indicating a MT SDT for a terminal device 210 to a first network device.

At block 1420, a second network device transfers a partial context of the terminal device 210 to the first network device without context relocation.

In some embodiments, transferring the partial context of the terminal device 210 to the first network device without context relocation comprises: receiving, a context request for retrieving the partial context of the terminal device 210 from the first network device; and transmitting a partial context of the terminal device 210 to the first network device.

In some embodiments, after a completion of an MT SDT, the second network device transmits an Xn message carrying an RRC release message for the terminal device 210.

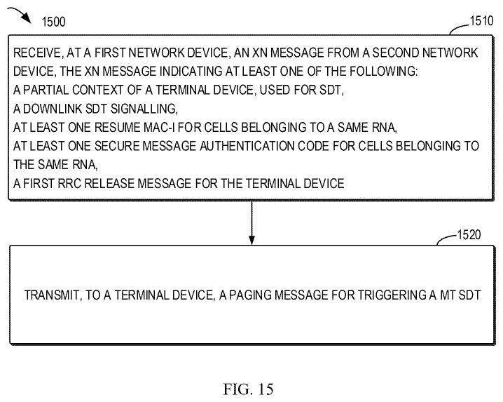

FIG. 15 illustrates a flowchart of an example method 1500 in accordance with some embodiments of the present disclosure. For example, the method 1500 can be implemented at the network device 220-1/220-2 as shown in FIG. 2.

At block 1510, a first network device receives an Xn message from a second network device, the Xn message indicating at least one of the following: a partial context of a terminal device 210, used for SDT, a downlink SDT signalling, at least one resume MAC-I for cells belonging to a same RNA, at least one secure message authentication code for cells belonging to the same RNA, a first RRC release message for the terminal device 210.

At block 1520, a first network device transmits, to a terminal device 210, a paging message for triggering a MT SDT.

In some embodiments, the Xn message is a RAN paging message.

In some embodiments, after transmitting the paging message, the first network device receives a first RRC resume request message for the MT SDT from the terminal device 210, and performs at least one of the following: verifying the terminal device 210 based on the at least one resume MAC-I or the at least one secure message authentication code comprised in the Xn message; or establishing an RLC entity based on the partial context comprised in the Xn message.

In some embodiments, after receiving the Xn message, the first network device transmits an Xn-U address indication to the second network device; and receives downlink SDT data from the second network device.

In some embodiments, transmitting the Xn-U address indication comprises: transmitting the Xn-U address indication upon one of the following: a reception the RAN paging message from the second network device, or a reception of a first RRC resume request message for the MT SDT from the terminal device 210.

In some embodiments, after a completion of the MT SDT, the first network device transmits, to the terminal device 210, a second RRC release message corresponding to the first RRC release message comprised in the Xn message.

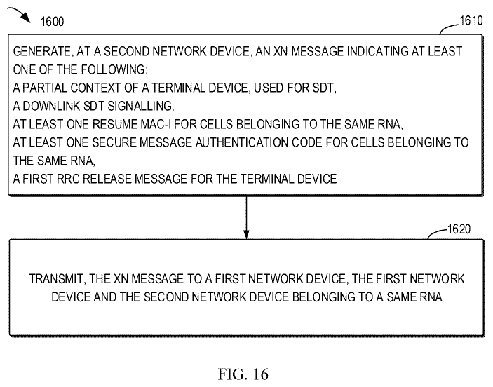

FIG. 16 illustrates a flowchart of an example method 1600 in accordance with some embodiments of the present disclosure. For example, the method 1600 can be implemented at the network device 220-1 as shown in FIG. 2.

At block 1610, a second network device generates an Xn message indicating at least one of the following: a partial context of a terminal device 210, used for SDT, a downlink SDT signalling, at least one resume MAC-I for cells belonging to the same RNA, at least one secure message authentication code for cells belonging to the same RNA, a first RRC release message for the terminal device 210.

At block 1620, a second network device transmits, the Xn message to a first network device, the first network device and the second network device belonging to a same RNA.

### Example of Apparatuses and Devices

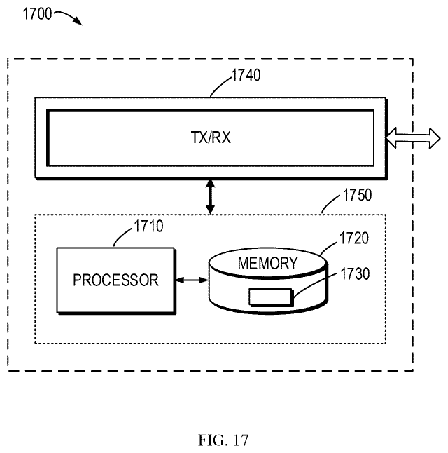

FIG. 17 is a simplified block diagram of a device 1700 that is suitable for implementing embodiments of the present disclosure. The device 1700 can be considered as a further example implementation of the terminal device 210 210 or the network device 220 220 as shown in FIG. 2. Accordingly, the device 1700 can be implemented at or as at least a part of the terminal device 210 210 or the network device 220.

As shown, the device 1700 includes a processor 1710, a memory 1720 coupled to the processor 1710, a suitable transmitter (TX)/receiver (RX) 1740 coupled to the processor 1710, and a communication interface coupled to the TX/RX 1740. The memory 1710 stores at least a part of a program 1730. The TX/RX 1740 is for bidirectional communications. The TX/RX 1740 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1730 is assumed to include program instructions that, when executed by the associated processor 1710, enable the device 1700 to operate in accordance with the embodiments of the present disclosure, as discussed herein with reference to FIGS. 2 to 16. The embodiments herein may be implemented by computer software executable by the processor 1710 of the device 1700, or by hardware, or by a combination of software and hardware. The processor 1710 may be configured to implement various embodiments of the present disclosure. Furthermore, a combination of the processor 1710 and memory 1720 may form processing means 17170 adapted to implement various embodiments of the present disclosure.

The memory 1720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1720 is shown in the device 1700, there may be several physically distinct memory modules in the device 1700. The processor 1710 may be of any type suitable to the local technical network, and may include one or more of general purpose computers, special purpose computers, microprocessors, digital signal processors (DSPs) and processors based on multicore processor architecture, as non-limiting examples. The device 1700 may have multiple processors, such as an application specific integrated circuit chip that is slaved in time to a clock which synchronizes the main processor.

In some embodiments, a terminal device 210 in an inactive state comprises a circuitry configured to: receives a paging message indicating a MT SDT from a first network device; determine, whether a condition for performing an uplink SDT is met; and transmit, based on a result of the determining, an RRC resume request message to the first network device.

In some embodiments, determining whether the condition for performing the uplink SDT is met comprises: determining the condition is met if a channel quality parameter of downlink pathloss reference is higher than a power threshold; or determining the condition is not met if the channel quality parameter of downlink pathloss reference is lower than or equals to than the power threshold.

In some embodiments, the channel quality parameter is an RSRP of downlink pathloss reference.

In some embodiments, determining whether the condition for performing the uplink SDT is met comprises: determining the condition is met if a data volume of pending uplink data across all RBs configured for SDT is less than or equals to a threshold volume; or determining the condition is not met if the data volume of the pending uplink data across all RBs configured for SDT is larger than the threshold volume.

In some embodiments, transmitting the RRC resume request message to the first network device comprises: in accordance with a determination that the condition or the set of conditions is met, transmitting a first RRC resume request message to the first network device, the first RRC resume request message indicating the MT SDT is initiated at the terminal device 210.

In some embodiments, the first RRC resume request message indicating the MT SDT is initiated at the terminal device 210 by comprising at least one of the following: a resume cause indicating MT SDT, or an identity of the terminal device 210 for MT SDT.

In some embodiments, transmitting the RRC resume request message to the first network device comprises: in accordance with a determination that the condition or at least one of the set of conditions is not met, transmitting a second RRC resume request message to the first network device, the second RRC resume request message indicating the MT SDT is not initiated at the terminal device 210.

In some embodiments, the second RRC resume request message indicating the MT SDT is not initiated at the terminal device 210 by comprising at least one of the following: a resume cause indicating MT access, or an inactive RSRP.

In some embodiments, the circuitry is further configured to: in accordance with a determination that the condition or the set of conditions is met, indicate, at a MAC entity of the terminal device 210, to an upper layer of the terminal device 210 that the condition is met.

In some embodiments, the circuitry is further configured to: in accordance with a determination that the condition or at least one of the set of conditions is not met, indicate at the MAC entity of the terminal device 210, to the upper layers of the terminal device 210 that the condition is not met.

In some embodiments, a first network device comprises a circuitry configured to: transmit, at a first network device and to a terminal device 210, a paging message indicating a MT SDT: and receive, a first RRC resume request message from a terminal device 210, the first RRC resume request message indicating the MT SDT is initiated at the terminal device 210.

In some embodiments, the first RRC resume request message comprises at least one of the following: a resume cause indicating MT SDT, or an identity of the terminal device 210 for MT SDT.

In some embodiments, a terminal device 210 comprises a circuitry configured to: receive an RRC release message from a second network device serving the terminal device 210, the RRC release message comprising at least one identity of the terminal device 210 for MT SDT; and enter into an inactive state.

In some embodiments, the at least one identity of the terminal device 210 for MT SDT is at least one RSRP for MT SDT.

In some embodiments, the at least one identity for MT SDT comprises at least one of the following: a first identity with a first bit length, or a second identity with a second bit length longer than the first bit length.

In some embodiments, the circuitry is further configured to: receive a paging message from a first network device, the paging message comprising one of the following: a 1-bit indication indicating whether the paging message is used for MT SDT, or one of the at least one identity of the terminal device 210 for MT SDT.

In some embodiments, the circuitry is further configured to: if an MT SDT is determined to be initiated, transmit a first RRC resume request message to the first network device, the first RRC request comprising one of the at least one identity of the terminal device 210.

In some embodiments, the circuitry is further configured to: receive SI from the first network device, the SI indicating whether a first identity with a first bit length or a second identity with a second bit length is to be used by the terminal device 210.

In some embodiments, the transmitting the first RRC resume request message comprises: if the SI indicates that the first identity with the first bit length is to be used, transmitting the first RRC resume request message with a first format; and if the SI indicates that the second identity with the second bit length is to be used, transmitting the first RRC resume request message with a second format different from the first format.

In some embodiments, a second network device serving a terminal device 210 comprises a circuitry configured to: generate, an RRC release message used for transitioning the terminal device 210 into an inactive state, the RRC release message comprising at least one identity of the terminal device 210 for MT SDT; and transmit the RRC release message to the terminal device 210.

In some embodiments, the at least one identity of the terminal device 210 for MT SDT is at least one RSRP for MT SDT.

In some embodiments, the at least one identity for MT SDT comprises at least one of the following: a first identity with a first bit length, or a second identity with a second bit length longer than the first bit length.

In some embodiments, the circuitry is further configured to: transmit SI to the terminal device 210, the SI indicating whether the first identity with the first bit length or the second identity with the second bit length is to be used by the terminal device 210.

In some embodiments, the circuitry is further configured to: transmit an Xn message comprising the at least one identity of the terminal device 210 for MT SDT to the second network device, the first network device and the second network device belonging to a same RNA.

In some embodiments, the Xn message is an RAN paging message.

In some embodiments, the circuitry is further configured to: transmit, to the terminal device 210, a paging message comprising at least one of the following: a 1-bit indication indicating whether the paging message is used for MT SDT, or one of the at least one identity of the terminal device 210 for MT SDT.

In some embodiments, a first network device comprises a circuitry configured to: transmit, at a first network device and to a terminal device 210, a paging message comprising one of the following: a 1-bit indication indicating whether the paging message is used for MT SDT, or one of the at least one identity of the terminal device 210 for MT SDT.

In some embodiments, the circuitry is further configured to: receive, from a second network device, an Xn message comprising at least one identity of a terminal device 210 for MT SDT, wherein the first network device and the second network device belong to a same RNA.

In some embodiments, the Xn message is an RAN paging message.

In some embodiments, the circuitry is further configured to: receive a first RRC resume request message from a terminal device 210, the first RRC request comprising one of the at least one identity of the terminal device 210.

In some embodiments, a first network device comprises a circuitry configured to: receive an RAN paging message indicating a MT SDT of a terminal device 210 from a second network device; transmit to the terminal device 210, a paging message for triggering the MT SDT; receive a first RRC resume request message for MT SDT from the terminal device 210; and retrieve a partial context of the terminal device 210 from the second network device without context relocation.

In some embodiments, retrieving the partial context of the terminal device 210 without context relocation comprises: transmitting, to the second network device, a context request for retrieving the partial context of the terminal device 210; and receiving, from the second network device, a partial context of the terminal device 210.

In some embodiments, the circuitry is further configured to: after a completion of the MT SDT, receive an Xn message from the second network device, the Xn message carrying a first RRC release message for the terminal device 210; and transmit, to the terminal device 210, a second RRC release message corresponding to the first RRC release message.

In some embodiments, a second network device comprises a circuitry configured to: transmit an RAN paging message indicating a MT SDT for a terminal device 210 to a first network device; and transfer a partial context of the terminal device 210 to the first network device without context relocation.

In some embodiments, transferring the partial context of the terminal device 210 to the first network device without context relocation comprises: receiving, a context request for retrieving the partial context of the terminal device 210 from the first network device; and transmitting a partial context of the terminal device 210 to the first network device.

In some embodiments, the circuitry is further configured to: after a completion of an MT SDT, transmit an Xn message carrying an RRC release message for the terminal device 210.

In some embodiments, a first network device comprises a circuitry configured to: receives an Xn message from a second network device, the Xn message indicating at least one of the following: a partial context of a terminal device 210, used for SDT, a downlink SDT signalling, at least one resume MAC-I for cells belonging to a same RNA, at least one secure message authentication code for cells belonging to the same RNA, a first RRC release message for the terminal device 210; and transmit, to a terminal device 210, a paging message for triggering a MT SDT.

In some embodiments, the Xn message is a RAN paging message.

In some embodiments, the circuitry is further configured to: after transmitting the paging message, receive a first RRC resume request message for the MT SDT from the terminal device 210, and perform at least one of the following: verifying the terminal device 210 based on the at least one resume MAC-I or the at least one secure message authentication code comprised in the Xn message; or establishing an RLC entity based on the partial context comprised in the Xn message.

In some embodiments, the circuitry is further configured to: after receiving the Xn message, transmit an Xn-U address indication to the second network device; and receive downlink SDT data from the second network device.

In some embodiments, transmitting the Xn-U address indication comprises: transmitting the Xn-U address indication upon one of the following: a reception the RAN paging message from the second network device, or a reception of a first RRC resume request message for the MT SDT from the terminal device 210.

In some embodiments, the circuitry is further configured to: after a completion of the MT SDT, transmit to the terminal device 210, a second RRC release message corresponding to the first RRC release message comprised in the Xn message.

In some embodiments, a second network device comprises a circuitry configured to: generate an Xn message indicating at least one of the following: a partial context of a terminal device 210, used for SDT, a downlink SDT signalling, at least one resume MAC-I for cells belonging to the same RNA, at least one secure message authentication code for cells belonging to the same RNA, a first RRC release message for the terminal device 210; and transmit, the Xn message to a first network device,

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a method of communication, comprising: receiving, at a terminal device in an inactive state and from a first network device, a paging message indicating a mobile-terminated (MT) small data transmission (SDT); determining, whether a condition or a set of conditions for performing an uplink SDT is met; and transmitting, based on a result of the determining, a radio resource control (RRC) resume request message to the first network device.

In some embodiments, determining whether the condition for performing the uplink SDT is met comprises: determining the condition is met if a channel quality parameter of downlink pathloss reference is higher than a power threshold; or determining the condition is not met if the channel quality parameter of downlink pathloss reference is lower than or equals to than the power threshold.

In some embodiments, the channel quality parameter is a reference signal receive power (RSRP) of downlink pathloss reference.

In some embodiments, determining whether the condition for performing the uplink SDT is met comprises: determining the condition is met if a data volume of pending uplink data across all radio bearers (RBs) configured for SDT is less than or equals to a threshold volume; or determining the condition is not met if the data volume of the pending uplink data across all RBs configured for SDT is larger than the threshold volume.

In some embodiments, transmitting the RRC resume request message to the first network device comprises: in accordance with a determination that the condition or the set of conditions is met, transmitting a first RRC resume request message to the first network device, the first RRC resume request message indicating the MT SDT is initiated at the terminal device.

In some embodiments, the first RRC resume request message indicating the MT SDT is initiated at the terminal device by comprising at least one of the following: a resume cause indicating MT SDT, or an identity of the terminal device for MT SDT.

In some embodiments, transmitting the RRC resume request message to the first network device comprises: in accordance with a determination that the condition or at least one of the set of conditions is not met, transmitting a second RRC resume request message to the first network device, the second RRC resume request message indicating the MT SDT is not initiated at the terminal device.

In some embodiments, the second RRC resume request message indicating the MT SDT is not initiated at the terminal device by comprising at least one of the following: a resume cause indicating MT access, or an inactive radio network temporary identity (RNTI).

In some embodiments, the method further comprises: in accordance with a determination that the condition or the set of conditions is met, indicating, at a media access control (MAC) entity of the terminal device, to an upper layer of the terminal device that the condition is met; and in accordance with a determination that the condition or at least one of the set of conditions is not met, indicating, at the MAC entity of the terminal device, to the upper layers of the terminal device that the condition is not met.

In one solution, a method of communication, comprising: transmitting, at a first network device and to a terminal device, a paging message indicating a mobile-terminated (MT) small data transmission (SDT); and receiving, a first radio resource control (RRC) resume request message from a terminal device, the first RRC resume request message indicating the MT SDT is initiated at the terminal device.

In some embodiments, the first RRC resume request message comprises at least one of the following: a resume cause indicating MT SDT, or an identity of the terminal device for MT SDT.

In one solution, a method of communication, comprising: receiving, at a terminal device and from a second network device serving the terminal device, a radio resource control (RRC) release message, the RRC release message comprising at least one identity of the terminal device for mobile-terminated (MT) small data transmission (SDT); and entering into an inactive state.

In some embodiments, the at least one identity of the terminal device for MT SDT is at least one radio network temporary identity (RNTI) for MT SDT.

In some embodiments, the at least one identity for MT SDT comprises at least one of the following: a first identity with a first bit length, or a second identity with a second bit length longer than the first bit length.

In some embodiments, the method further comprises: receiving a paging message from a first network device, the paging message comprising one of the following: a 1-bit indication indicating whether the paging message is used for MT SDT, or one of the at least one identity of the terminal device for MT SDT.

In some embodiments, the method further comprises: if an MT SDT is determined to be initiated, transmitting a first RRC resume request message to the first network device, the first RRC request comprising one of the at least one identity of the terminal device.

In some embodiments, the method further comprises: receiving system information (SI) from the first network device, the SI indicating whether a first identity with a first bit length or a second identity with a second bit length is to be used by the terminal device.

In some embodiments, the transmitting the first RRC resume request message comprises: if the SI indicates that the first identity with the first bit length is to be used, transmitting the first RRC resume request message with a first format; and if the SI indicates that the second identity with the second bit length is to be used, transmitting the first RRC resume request message with a second format different from the first format.

In one solution, a method of communication, comprising: generating, at a second network device serving a terminal device, a radio resource control (RRC) release message used for transitioning the terminal device into an inactive state, the RRC release message comprising at least one identity of the terminal device for mobile-terminated (MT) small data transmission (SDT); and entering into an inactive state.

In some embodiments, the at least one identity of the terminal device for MT SDT is at least one radio network temporary identity (RNTI) for MT SDT.

In some embodiments, the at least one identity for MT SDT comprises at least one of the following: a first identity with a first bit length, or a second identity with a second bit length longer than the first bit length.

In some embodiments, the method further comprises: transmitting system information (SI) to the terminal device, the SI indicating whether the first identity with the first bit length or the second identity with the second bit length is to be used by the terminal device.

In some embodiments, the method further comprises: transmitting an Xn message comprising the at least one identity of the terminal device for MT SDT to a first network device, the first network device and the second network device belonging to a same radio access network (RAN) notification area (RNA).

In some embodiments, the Xn message is an RAN paging message.

In some embodiments, the method further comprises: transmitting, to the terminal device, a paging message comprising at least one of the following: a 1-bit indication indicating whether the paging message is used for MT SDT, or one of the at least one identity of the terminal device for MT SDT.

In one solution, a method of communication, comprising: transmitting, at a first network device and to a terminal device, a paging message comprising one of the following: a 1-bit indication indicating whether the paging message is used for mobile-terminated (MT) small data transmission (SDT), or one of the at least one identity of the terminal device for MT SDT.

In some embodiments, the method further comprises: receiving, from a second network device, an Xn message comprising at least one identity of a terminal device for MT SDT, wherein the first network device and the second network device belong to a same radio access network (RAN) notification area (RNA).

In some embodiments, the Xn message is an RAN paging message.

In some embodiments, the method further comprises: receiving a first RRC resume request message from a terminal device, the first RRC request comprising one of the at least one identity of the terminal device.

In one solution, a method of communication, comprising: receiving, at a first network device and from a second network device, a radio access network (RAN) paging message indicating a mobile-terminated (MT) small data transmission (SDT) of a terminal device; transmitting, to the terminal device, a paging message for triggering the MT SDT; receiving a first RRC resume request message for MT SDT from the terminal device; and retrieving a partial context of the terminal device from the second network device without context relocation.

In some embodiments, retrieving the partial context of the terminal device without context relocation comprises: transmitting, to the second network device, a context request for retrieving the partial context of the terminal device; and receiving, from the second network device, a partial context of the terminal device.

In some embodiments, the method further comprises: after a completion of the MT SDT, receiving an Xn message from the second network device, the Xn message carrying a first radio resource control (RRC) release message for the terminal device; and transmitting, to the terminal device, a second RRC release message corresponding to the first RRC release message.

In one solution, a method of communication, comprising: transmitting, at a second network device and to a first network device, a radio access network (RAN) paging message indicating a mobile-terminated (MT) small data transmission (SDT) for a terminal device; and transferring a partial context of the terminal device to the first network device without context relocation.

In some embodiments, transferring the partial context of the terminal device to the first network device without context relocation comprises: receiving, a context request for retrieving the partial context of the terminal device from the first network device; and transmitting a partial context of the terminal device to the first network device.

In some embodiments, the method further comprises: after a completion of an MT SDT, transmitting to the first network device, an Xn message carrying a radio resource control (RRC) release message for the terminal device.

In one solution, a method of communication, comprising: receiving, at a first network device, an Xn message from a second network device, the Xn message indicating at least one of the following: a partial context of a terminal device, used for small data transmission (SDT), a downlink SDT signalling, at least one resume MAC-I for cells belonging to a same RNA, at least one secure message authentication code for cells belonging to the same RNA, a first radio resource control (RRC) release message for the terminal device; and transmitting, to a terminal device, a paging message for triggering a mobile-terminated (MT) SDT.

In some embodiments, the Xn message is an RAN paging message.

In some embodiments, the method further comprises: after transmitting the paging message, receiving a first RRC resume request message for the MT SDT from the terminal device, and performing at least one of the following: verifying the terminal device based on the at least one resume MAC-I or the at least one secure message authentication code comprised in the Xn message; or establishing a radio link control (RLC) entity based on the partial context comprised in the Xn message.

In some embodiments, the method further comprises: after receiving the Xn message, transmitting an Xn-U address indication to the second network device; and receiving downlink SDT data from the second network device.

In some embodiments, transmitting the Xn-U address indication comprises: transmitting the Xn-U address indication upon one of the following: a reception the RAN paging message from the second network device, or a reception of a first RRC resume request message for the MT SDT from the terminal device.

In some embodiments, the method further comprises: after a completion of the MT SDT, transmitting, to the terminal device, a second RRC release message corresponding to the first RRC release message comprised in the Xn message.

In one solution, a method of communication, comprising: generating, at a second network device, an Xn message indicating at least one of the following: a partial context of a terminal device, used for small data transmission (SDT), a downlink small data transmission (SDT) signalling, at least one resume MAC-I for cells belonging to the same RNA, at least one secure message authentication code for cells belonging to the same RNA, a first radio resource control (RRC) release message for the terminal device; and transmitting, the Xn message to a first network device, the first network device and the second network device belonging to a same radio access network (RAN) notification area (RNA).

In another solution, a device of communication comprises: a processor configured to cause the device to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 16. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication, comprising:
receiving, at a terminal device in an inactive state and from a first network device, a paging message indicating a mobile-terminated, MT, small data transmission, SDT;
determining, whether a condition or a set of conditions for performing an uplink SDT is met; and
transmitting, based on a result of the determining, a radio resource control, RRC, resume request message to the first network device.

2. The method of claim 1, wherein determining whether the condition for performing the uplink SDT is met comprises:
determining the condition is met if a channel quality parameter of downlink pathloss reference is higher than a power threshold; or
determining the condition is not met if the channel quality parameter of downlink pathloss reference is lower than or equals to than the power threshold.

3. The method of claim 2, wherein the channel quality parameter is a reference signal receive power, RSRP, of downlink pathloss reference.

4. The method of claim 1, wherein determining whether the condition for performing the uplink SDT is met comprises:
determining the condition is met if a data volume of pending uplink data across all radio bearers, RBs, configured for SDT is less than or equals to a threshold volume; or
determining the condition is not met if the data volume of the pending uplink data across all RBs configured for SDT is larger than the threshold volume.

5. The method of claim 1, wherein transmitting the RRC resume request message to the first network device comprises:
in accordance with a determination that the condition or the set of conditions is met, transmitting a first RRC resume request message to the first network device, the first RRC resume request message indicating the MT SDT is initiated at the terminal device.

6. The method of claim 5, wherein the first RRC resume request message indicating the MT SDT is initiated at the terminal device by comprising at least one of the following:
a resume cause indicating MT SDT, or
an identity of the terminal device for MT SDT.

7. The method of claim 1, wherein transmitting the RRC resume request message to the first network device comprises:
in accordance with a determination that the condition or at least one of the set of conditions is not met, transmitting a second RRC resume request message to the first network device, the second RRC resume request message indicating the MT SDT is not initiated at the terminal device.

8. The method of claim 7, wherein the second RRC resume request message indicating the MT SDT is not initiated at the terminal device by comprising at least one of the following:
a resume cause indicating MT access, or
an inactive radio network temporary identity, RNTI.

9. The method of claim 1, further comprising:
in accordance with a determination that the condition or the set of conditions is met, indicating, at a media access control, MAC, entity of the terminal device, to an upper layer of the terminal device that the condition is met; and
in accordance with a determination that the condition or at least one of the set of conditions is not met, indicating, at the MAC entity of the terminal device, to the upper layers of the terminal device that the condition is not met.

10. A method of communication, comprising:
receiving, at a terminal device and from a second network device serving the terminal device, a radio resource control, RRC, release message, the RRC release message comprising at least one identity of the terminal device for mobile-terminated, MT, small data transmission, SDT; and
entering inactive state.

11. The method of claim 10, wherein the at least one identity of the terminal device for MT SDT is at least one radio network temporary identity, RNTI, for MT SDT.

12. The method of claim 10, wherein the at least one identity for MT SDT comprises at least one of the following:
a first identity with a first bit length, or
a second identity with a second bit length longer than the first bit length.

13. The method of claim 10, further comprising:
receiving a paging message from a first network device, the paging message comprising one of the following:
a 1-bit indication indicating whether the paging message is used for MT SDT, or one of the at least one identity of the terminal device for MT SDT.

14. The method of claim 13, further comprising:
if an MT SDT is determined to be initiated, transmitting a first RRC resume request message to the first network device, the first RRC request comprising one of the at least one identity of the terminal device.

15. A method of communication, comprising:
transmitting, at a first network device and to a terminal device, a paging message comprising one of the following:
a 1-bit indication indicating whether the paging message is used for mobile-terminated, MT, small data transmission, SDT, or
one of the at least one identity of the terminal device for MT SDT.

16. The method of claim 15, further comprising:
receiving, from a second network device, an Xn message comprising at least one identity of a terminal device for MT SDT,
wherein the first network device and the second network device belong to a same radio access network, RAN, (RAN) notification area, RNA (RNA).

17. The method of claim 16, wherein the Xn message is an RAN paging message.

18. The method of claim 15, further comprising:
receiving a first RRC resume request message from a terminal device, the first RRC request comprising one of the at least one identity of the terminal device.
